(19) United States
(12) Patent Application Publication
(10) Pub. No.: US 2005/0238850 A1
(43) Pub. Date: Oct. 27, 2005

(54) System for laying and substituting facing overlays, a method for laying and removing facing overlays, and a flexible support means

(76) Inventors: Jose Celso Barbosa JR., Santa Catarina State (BR); Vilmar Manegon Bristot, Santa Catarina State (BR); Jesler Savi Freitas, Sao Paulo State (BR); Edson Gaidzinski JR., Sao Paulo State (BR)

Correspondence Address: PEARNE & GORDON LLP, 1801 EAST 9TH STREET, SUITE 1200, CLEVELAND, OH, 44114-3108, US

(21) Appl. No.: 11/072,828

(22) Filed: Mar. 4, 2005

(30) Foreign Application Priority Data
Mar. 4, 2004 (BR) PI 0400389-6

(51) Int. Cl. B32B 3/28

(52) U.S. Cl. 428/167

(57) ABSTRACT

The present invention comprises a system that allows the overlaying of surfaces in a faster and cleaner manner, contributing to the process the ability to replace and reuse facing overlays without the risk of damaging the surfaces and the facing overlay intended to be removed.

### FIELD OF APPLICATION

The present invention is related to surface overlays, namely floor and wall overlaid facing materials, and it is more particularly related to a system for placement and replacement of facing elements, particularly ceramic plates and tiles, and to a method for placement and replacement thereof, and also to a flexible support element which integrates the system.

### BACKGROUND OF THE INVENTION

The most widely used techniques for overlaying surfaces with modular elements, typically comprised of ceramic floor plates and tiles, make use of materials that provide a permanent attachment of the facing elements, such as for example cement-based mortar formulations or adhesives with high bonding strength that invariably impose a burden on the efforts required to replace or remove the overlaid elements, most often requiring that the latter be destroyed. The system according to the present invention differs from the traditional methods in that it employs a flexible support element and an adhesive to glue the same to the substrate, in that it makes use of a flexible sealing material, and in that it provides several advantages over the traditional methods, among which there should be pointed out the possibility of exchanging or replacing the overlay plates, both easily and without losses.

### SUMMARY OF THE INVENTION

The present invention comprises a system that allows overlaying of surfaces in a faster and cleaner manner, adding to the process the capability of exchanging and reusing the overlays without risking damage to the surfaces, thus providing substantial advantages over the traditional systems.

As shown in detail in FIGS. 1 and 2, the inventive system provides the overlaying of surfaces by means of placement thereon, upon the same having been duly evened out or leveled, of flexible supports shaped in rubber, silicone, neoprene or similar materials, whereby the supports are affixed to the substrate by means of an adhesive compound. The facing elements, shaped in ceramic, wood, metal, natural stone or similar materials, are affixed onto the flexible supports using an easily removable adhesive compound, and the supports may be provided with retaining means or tabs that will provide a guide means for positioning the overlaying elements and for providing the interval therebetween to be filled with sealing grout.

The system further provides a tight seal against surface infiltration of fluids, which seal is ensured by filling the spaces between the overlay elements with a flexible sealing grout which may consist in silicone, an acrylic-base compound, mixtures thereof or similar materials, which polymerizes or sets with time and becomes flexible and tight, and which is directly applied in place upon installation of the overlay on the flexible support, with this latter already in place on the substrate.

One of the main advantages of the system for overlaying on flexible supports consists in the easiness with which the laid facing may be replaced or substituted, which also applies to the installed assembly, the flexible support with the facing laid thereon, without incurring loss or damage of the facing to be removed and/or of the flexible support and without damaging the substrate over which the flexible supports are laid.

One other advantage comparatively to known systems consists in the ability to replace the flexible tight sealing grout without damaging the substrate over which the flexible supports are laid.

The flexible system, differently from traditional systems using cement-based mortar, lessens the requirement of expansion joints due to its inherent flexibility; and due to being interchangeable and flexible it may overlay the joint rendering the system seamless and uniform.

In summary, the advantages perceived in connection with the use of this system as compared to the traditional systems cited above comprise:
installation with immediate clearance to traffic in the case of systems with no application of sealing grout and early clearance to traffic in the case of systems using sealing grout;
dry type installation, without requiring the use of wet materials;
cleaner environment in laying, removal and replacement operations;
easy installation with no need to use guides or spacers between parts to align the same, since such functions are performed by the flexible support itself;
low requirement of skilled labor for laying, maintenance and replacement;
capability of installation over various types of leveled surfaces (concrete; wood; metal; ceramic; glass; vinyl and others);
acoustic insulation (soundproofing) of the environment;
thermal insulation of the environment;
lighter structure;
lower requirement of installation of expansion joints;
greater tightness of the surface and lesser efflorescence on the surface of the overlays;
possibility of installation on raised floors;
faster replacement of the overlays;
replacement without destruction of the overlays, allowing the replaced overlay elements to be reused;
faster installation, removal and substitution operations;
easy change of aesthetic pattern of the environments;
easier maintenance of the overlaid surfaces such as in cases of infiltration in ceiling slabs or walls;
easy replacement of grout (flexible tight sealing paste).

### BRIEF DESCRIPTION OF THE DRAWINGS

FIG. 1 is an exploded schematic view depicting the installation of the flexible support (2) and the facing (3) on a substrate (1), more specifically on a floor lining;

FIG. 2 is an exploded schematic view depicting the installation of the flexible support (2) and the facing (3) on a substrate (1), more specifically on a wall;

FIG. 3 shows the sealing operation carried out using a flexible sealing paste with the facing already overlaid on the substrate;

FIG. 4 is a perspective view (8) of an assembly of flexible supports (2) with channels (4) for passage of electrical wiring, with an additional side view of the same assembly;

FIG. 5 is a schematic perspective view of a wall (5) with the application of facing overlays over flexible supports of different sizes;

FIG. 6 is a perspective view of an assembly formed by flexible supports in combination;

FIG. 7 shows a side view (10) and a perspective view (11) of the flexible support with an engagement system with side support guides (7);

FIG. 8 is a perspective view depicting (a) the operation performed to cut the facing plate and the support for performance of finishing and cutout operations and work on details;

FIG. 9 is a schematic illustration of the operation carried out to cut the sealing element in order to remove the facing overlay;

FIGS. 10 and 11 are schematic illustrations of the operation carried out for removal of the facing overlay with the aid of a lever; and

FIGS. 12 and 13 are schematic illustrations of the operation performed to withdraw and lay a new facing.

### DETAILED DESCRIPTION OF THE INVENTION

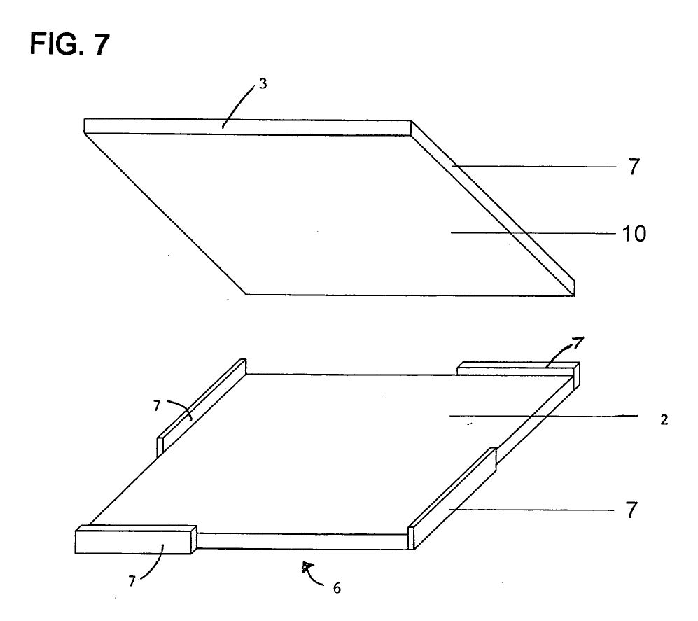

As shown in the attached drawings, the invention provides a flexible support that is depicted in FIG. 7, which, for purposes of description but in no way limiting the scope of the invention thereto, is represented with a square shape, the support consisting in a shaped piece of a flexible material such as rubber, silicone, neoprene, mixtures thereof or similar materials, preferably obtained by molding, the support being provided with a side engagement system (6) and side support guides or tabs (7), which ensure the positioning of the facing plate to be held by the flexible support. These guides have the dual function of contributing to full fastening and accurate positioning of the facing that will be held thereat and of providing the interconnection between the support-facing assemblies on the side engagement portions of the piece to be installed in one or more of its sides. This side interconnection feature is also responsible for the self-alignment of the system on installation, thus obviating any requirement of external guide means and spacers between pieces.

The shape of the flexible support may be varied to conform to the shape of the facing plates available in the market, and the upper and lower parts of the flexible support may be continuous or optionally they may be provided in the form of a series of hollow insertions.

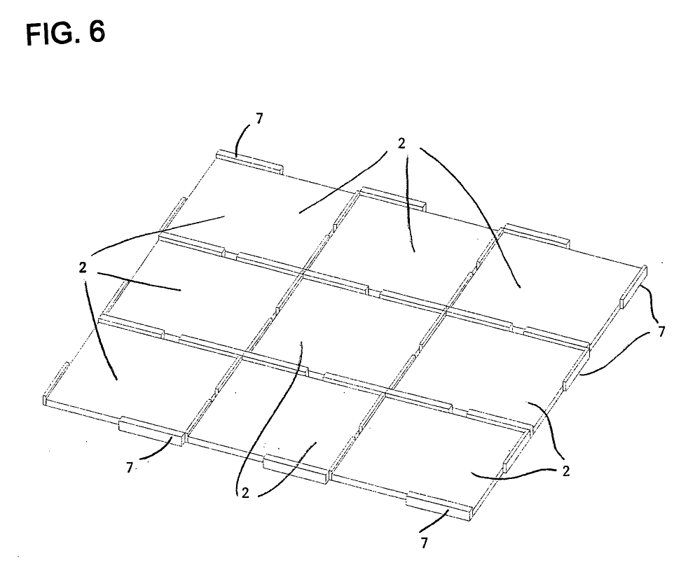

The flexible support is represented, for purposes of description thereof, in its preferred form, a square polygon, with supporting guides (7) provided on each side of the flexible support, and the flexible support may be provided in a form combining one or more supports together forming an assembly as shown in FIG. 6.

### Installation of the System

The installation should be performed on a clean substrate, devoid of dust, oil or any substance that might prevent adequate bonding of the adhesive used for fastening the flexible bases, and the substrate should also be evened out to a level surface and should have sufficient mechanical strength to meet its use requirements, it should be homogenous in terms of its physical characteristics, devoid of fissures, water seepage or infiltrations and other apparent defects that might entail damage to the system.

If the surface intended to be overlaid is excessively uneven, it might be convenient to cover the paving with a level adjustment layer. If necessary, depending on the area to be overlaid, the flexible coatings may be previously cut to measure for the project.

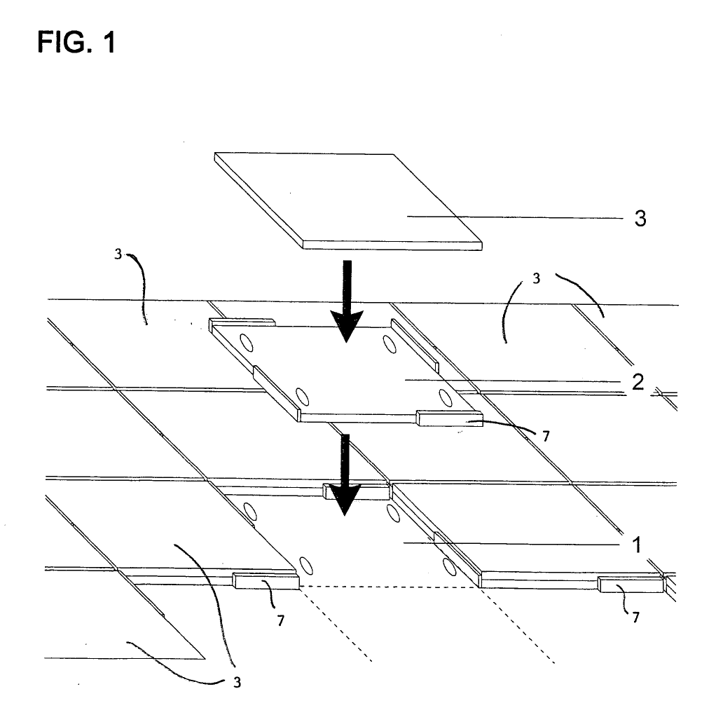

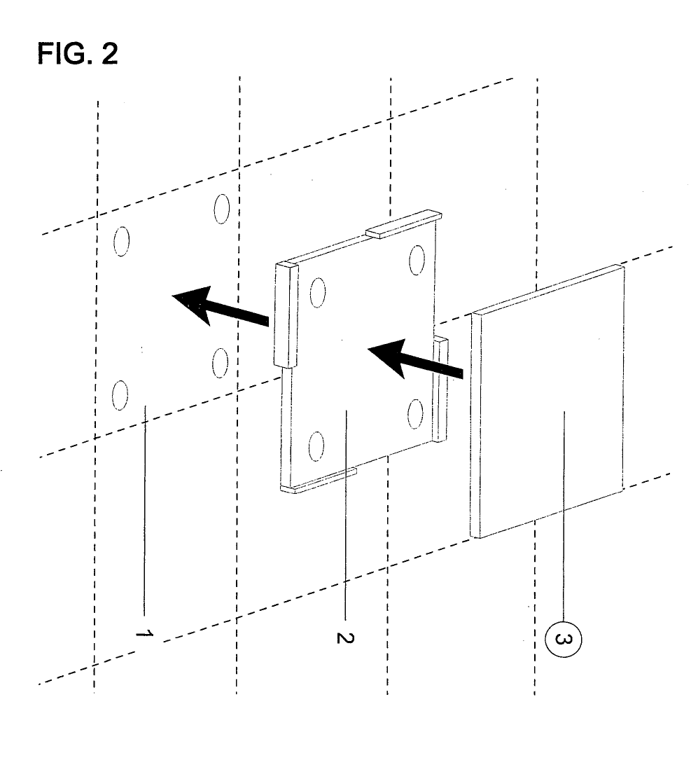

Upon there having been checked the conditions of the substrate, there is started the installation, where the flexible support and the facing should be previously attached to one another making up an integral assembly, whereupon the assembly comprising the flexible support and the facing, with the underside thereof coated with a film of adhesive, is laid on the substrate, as shown in FIGS. 1 and 2.

Continuing the installation, the remaining assemblies comprised of flexible support and overlay facing are installed such as to fit laterally with one of the edges of the previously installed piece, and in such way as to avoid lateral coincidence of the guides of the flexible supports of the respective assemblies at the time of installation of the second one.

After laying each assembly there should be applied a light pressure on the facing side to ensure adequate attachment of the binding adhesive provided on the underside thereof onto the substrate, and such laying routine should be performed throughout the area intended to be furnished with the overlay.

Immediately upon completing the laying of the assemblies there should be started the step of application of tight sealing paste to the joints located between the assemblies and between the assemblies and the substrates and/or any existing columns. Prior to beginning of application of the sealing paste there should be made sure that the joints to be filled are clean, devoid of dust, oil or any substance that might prevent proper adherence of the paste.

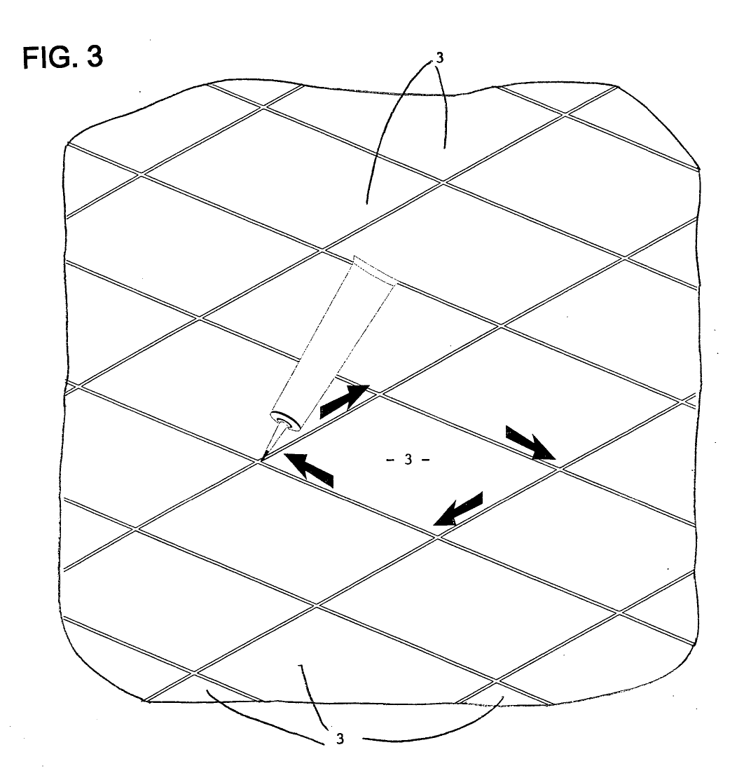

The sealing paste is applied diagonally in relation to the joints, over small areas, with the help of a putty knife or spatula or a dispensing gun of the type used to apply silicone sealant, as shown in FIG. 3. The paste placed at the surface of the joint should be manually pressed into filling the joint along the entire length thereof and any excess paste should be removed immediately after application.

Upon the application and partial setting of the applied paste, the surface areas of the facing to the sides of the joints should be cleaned with a clean, slightly wet cloth, moving the cloth smoothly over the surfaces.

Upon cleaning the side areas, the place where the system was applied should be completely cleaned and isolated for a time sufficient to allow full setting and stabilization of the system, prior to beginning to use the same as intended.

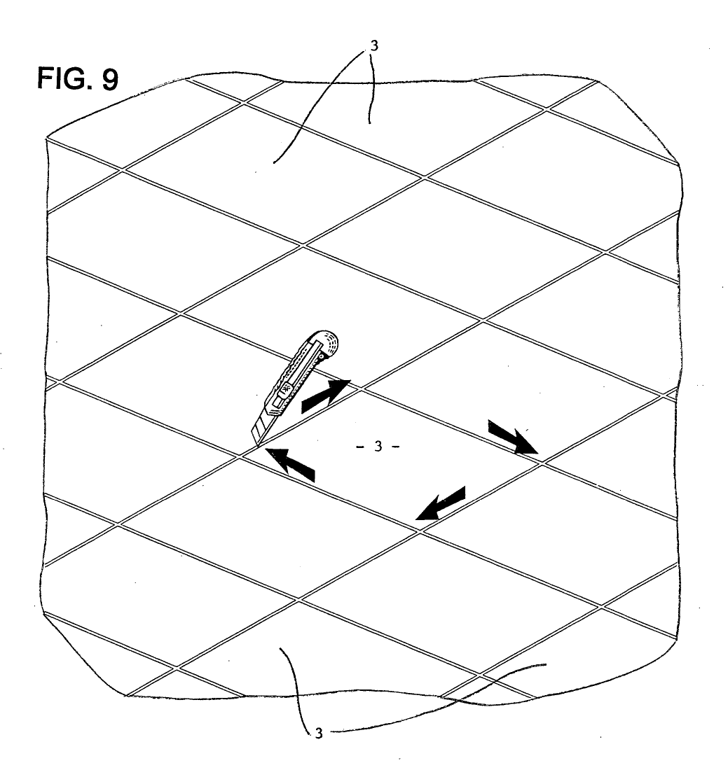

The replacement of the system should begin by cutting the flexible grout with a stylus or a similar tool, at the region intended to be replaced as shown in FIG. 9.

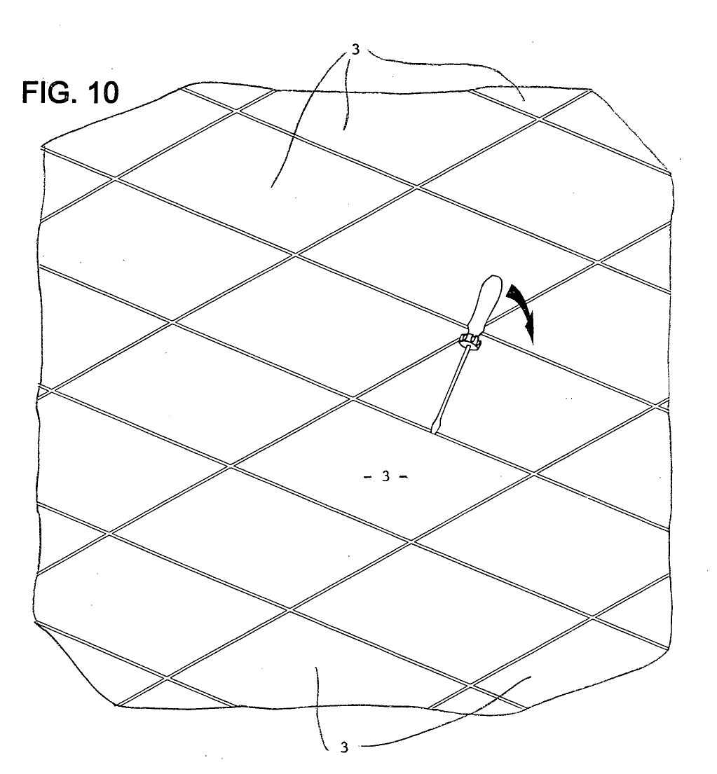

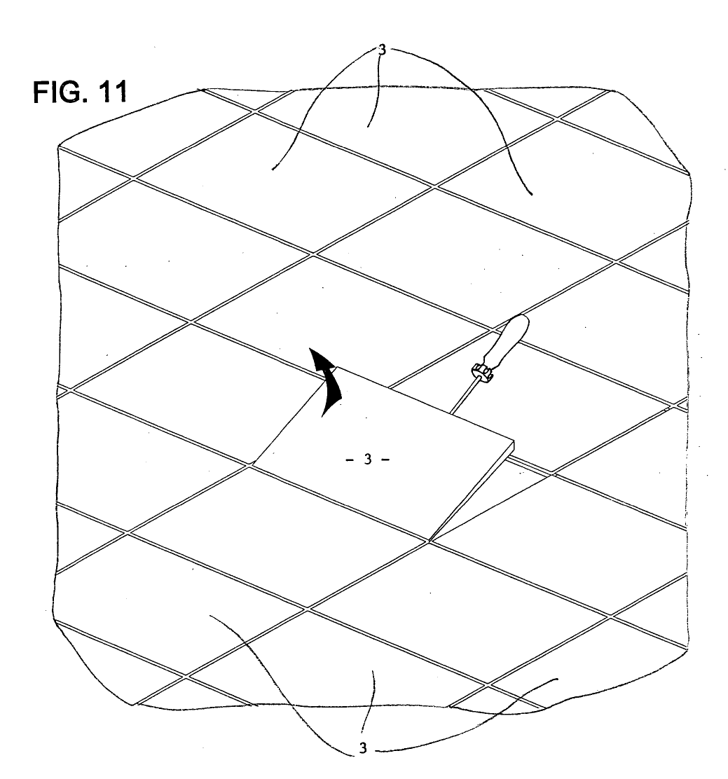

The incision should be made longitudinally along the joint, taking care to restrict the incision to a shallow depth and to avoid disrupting the flexible substrate. Upon cutting the sealing paste, the facing plate is withdrawn, in the case of a partial replacement operation, or the whole assembly is withdrawn in case of integral replacement of the system. In both cases it is necessary to detach the part intended to be removed, using a lever or a sucking device, as shown in FIGS. 10 and 11.

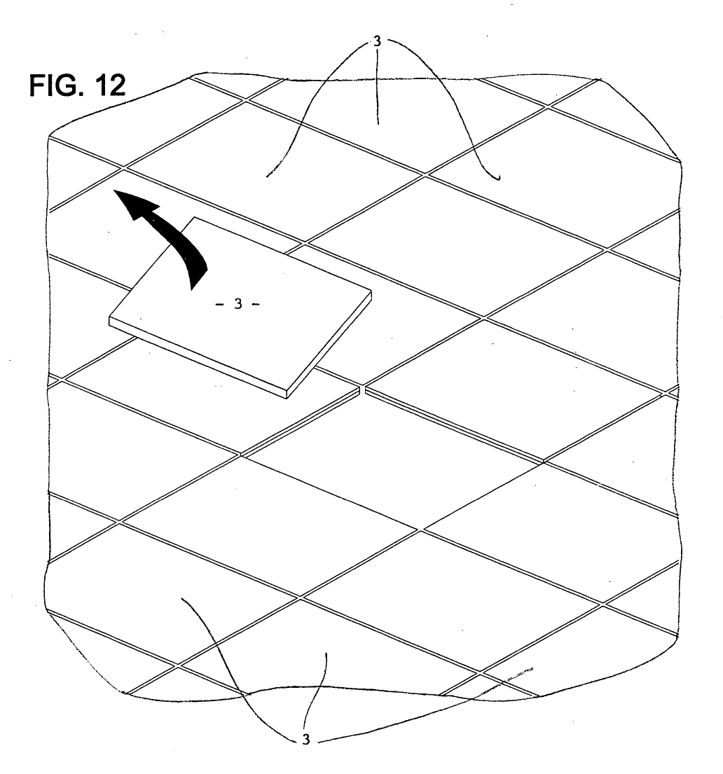

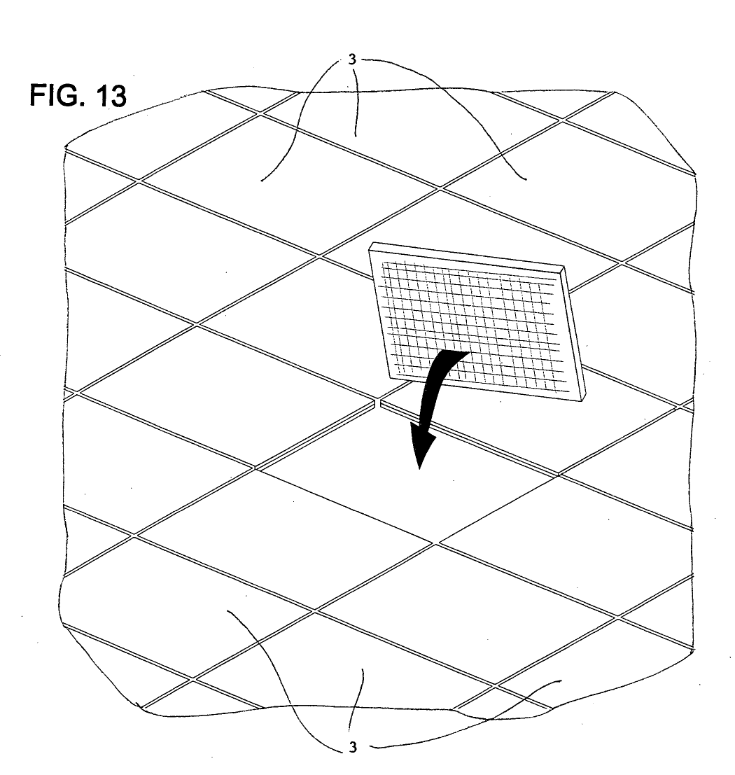

Upon removal and substitution of the facing overlays, as shown in FIGS. 12 and 13, there should be performed the cleaning of the surface to be newly overlaid to avoid any accumulation of foreign matter or residue of the previously used adhesive.

There should be pointed out that the binding strength of the adhesive used on the underside of the flexible support is higher that that of the internal adhesive, applied on the upper face of the flexible support, which fastens the facing overlay to the upper face of the flexible support, factor facilitating partial removal of the system without the risk of damaging the attachment of the flexible support to the substrate.

Finally, there should be performed the filling of the edges between the facing overlays, using a flexible and tight sealing paste, as shown in FIG. 3.

In its constructive modalities, the system allows some additional benefits.

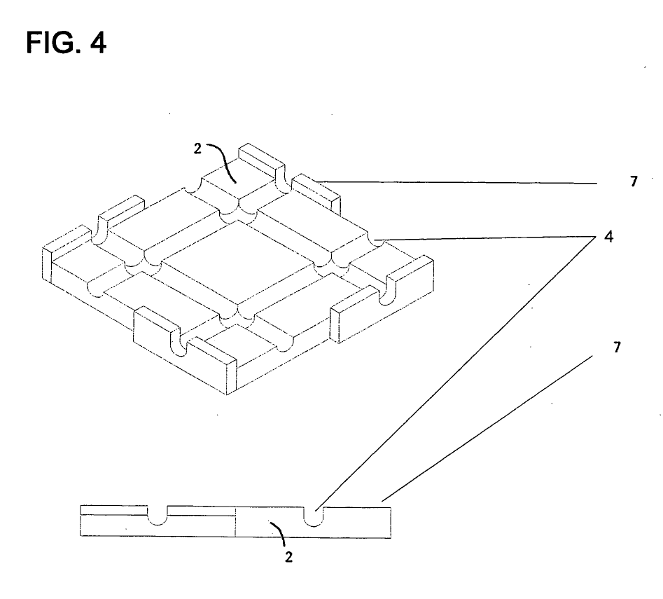

One first modality would consist in the system comprising channels to receive electrical wiring, as shown in FIG. 4, using the flexible support provided with transversal channels (4) machined on the surface of the supports to allow the passage of electrical wiring.

The use of this modality allows the transmission of electrical, optical and voice communication signals and electrical resistors for heating and other purposes along circuitry installed beneath the facing overlays, and it further allows maintenance or change of points of reception or generation of the signals or charges without the need to destroy the facings.

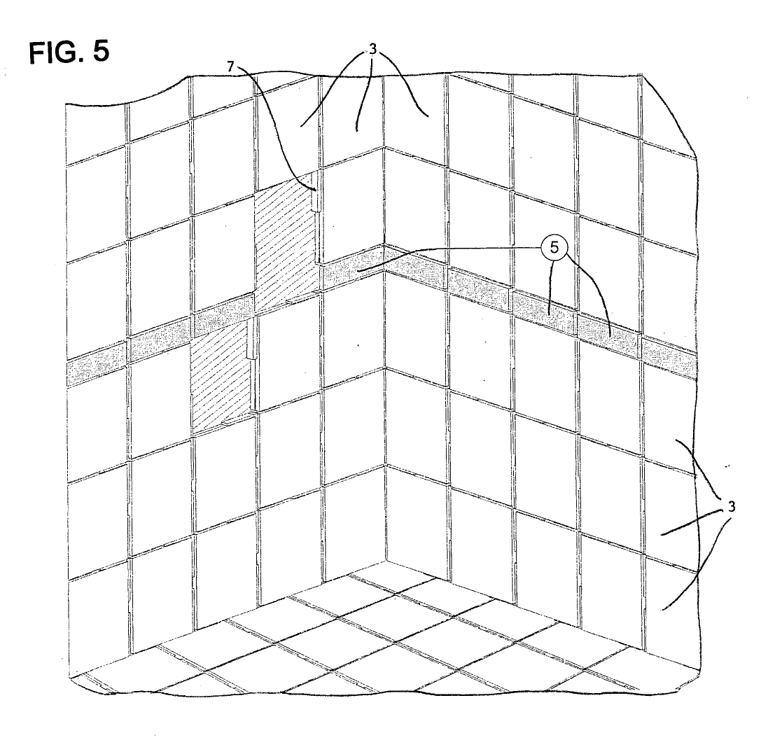

One other modality of the system disclosed herein allows the use thereof as a supporting means for decorative elements, as shown in FIG. 5, with use of complementary parts for decorative purposes (5). These parts are carried by flexible supports having the same properties of the regular supports, however with shapes allowing the inclusion of mosaics, triangles, bands, strips and other surface decoration elements.

In FIG. 6 there is shown one other modality of the flexible support in a combination version (single piece), allowing simultaneous installation of more than one facing overlay. This optional application of the system is ideal for large areas of installation of regular facing overlays without decorative complements or other constructive details.

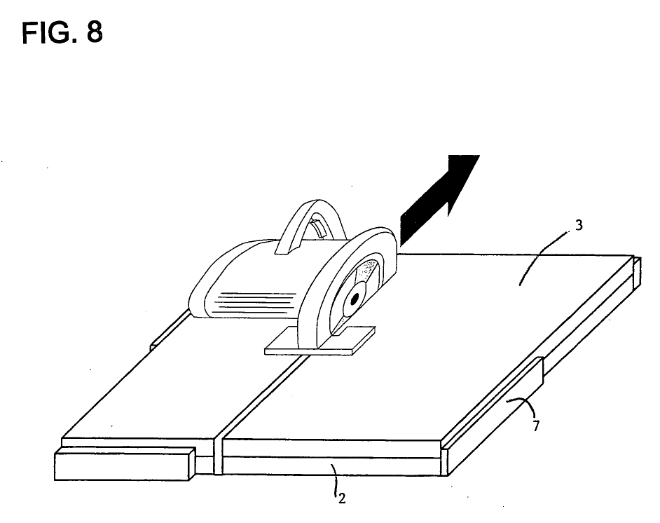

In FIG. 8 there is shown in a perspective view the operation performed to cut the facing plate and the support for performance of finishing work, cutouts and details, allowing the system of the present invention to be adapted to the flooring intended to be applied, irrespective of the area to be covered. Notwithstanding the cut made as shown in FIG. 8, the guides maintain a substantial level of uniformity in the support-facing assembly to be installed.

Although the present invention was described in terms of a presently preferred embodiment hereof, there should be understood that such embodiment is not intended to be construed as limitative in regard of the same, and that changes and modifications hereto will be apparent to persons skilled in the art in light of the benefit provided by the preceding description. As such, the invention may be limited solely by the scope of the claims that follow.

1. A system for laying and substituting facing overlays, characterized by comprising a flexible support, a facing overlay adequate to the said flexible support and a flexible adhesive paste.

2. A system according to claim 1, characterized in that the flexible support is provided separately, in a configuration adequate to the facing overlay intended to be installed, and is produced to have acoustic, electrical and thermal insulation characteristics.

3. A system according to claim 1, characterized in that the flexible support is provided in combination with one or more flexible supports, forming a single piece.

4. A system according to claim 1, characterized in that it is applied to floors and walls.

5. A system according to claim 1, characterized in that the attachment of the flexible support to the substrate and the attachment of the facing overlay to the flexible support is provided by adhesive, and the adhesive substance used is preferably a glue adhesive substance.

6. A system according to claim 1, characterized in that the facing overlay to be installed is selected from the group consisting in ceramic, wood, metal, natural stones, plastics, mixtures thereof or similar materials.

7. A flexible support, according to claim 1, characterized in that the support is combined with one or more supports, in a continuous manner, in order to form a single piece.

8. A system, according to claim 1, characterized in that the flexible support has channels in its underside for passage of electrical wiring, cables and pipes and that he system allows the passage, installation, removal and maintenance of said wires, cables and pipes.

9. A system, according to claim 1, characterized in that the flexible support has pipes incorporated in its underside for passage of wires and cables.

10. A flexible support characterized by being shaped in flexible material and provided with a side engagement system and supporting guides, the supporting guides extending laterally on each side of the flexible support.

11. A flexible support, according to claim 10, characterized in that the supporting guides attach the facing overlay to the support and interconnect laterally the flexible support with one other contiguous flexible support.

12. A flexible support, according to claim 10, characterized in that the support is provided in a square shape with a supporting guide on each side thereof.

13. A flexible support, according to claim 10, characterized in that the underside and/or the upper side of the support is provided with grooves or depressions.

14. A flexible support, according to claim 10, characterized by having channels in its underside for passage of wires, cables and pipes.

15. A method for installation of facing overlays, characterized by comprising the steps of:
attachment of a facing overlay onto a compatible flexible support;
application of sealing paste into the joints formed between the already laid assemblies comprised of facing overlay and support, as well as into the joints formed between the said assemblies and walls, columns, ceilings, and similar elements;
impressions of the paste thus applied to entirely fill the joint whereto the said paste was applied.

16. A method, according to claim 15, characterized in that the step of attachment of the facing overlay to the flexible support takes place after the attachment of the flexible support onto the substrate.

17. A method, according to claim 15, characterized by comprising, in addition, the step of preparation of the substrate prior to the step of application of the flexible support.

18. A method for removal of a facing overlay, characterized by comprising the steps of:
cutting the flexible grout;
extraction of the flexible paste; and
withdrawal of the facing overlay using a dedicated instrument, by means of a levering action performed therewith.

19. A method, according to claim 18, characterized in that the levering action is performed using a sufficiently rigid instrument capable of withstanding sufficient force to detach the facing overlay.

20. A method for removal of a facing overlay, characterized by comprising the steps of:
cutting the flexible grout;
extraction of the flexible paste located around the facing overlay intended to be removed;
removal of the facing overlay bound by adhesive to the flexible support, using a dedicated instrument by means of a levering action performed therewith; and
removal of the flexible support bound by adhesive to the substrate, using a dedicated instrument by means of a levering action performed therewith,
wherein the levering action is performed using a sufficiently rigid instrument capable of withstanding sufficient force to detach the facing overlay.

21. A system according to claim 2, characterized in that it is applied to floors and walls.

22. A system according to claim 3, characterized in that it is applied to floors and walls.

23. A system according to claim 2, characterized in that the attachment of the flexible support to the substrate and the attachment of the facing overlay to the flexible support is provided by adhesive, and the adhesive substance used is preferably a glue adhesive substance.

24. A system according to claim 3, characterized in that the attachment of the flexible support to the substrate and the attachment of the facing overlay to the flexible support is provided by adhesive, and the adhesive substance used is preferably a glue adhesive substance.

25. A flexible support, according to claim 11, characterized in that the support is provided in a square shape with a supporting guide on each side thereof.

26. A method, according to claim 16, characterized by comprising, in addition, the step of preparation of the substrate prior to the step of application of the flexible support.
